(19) United States
(12) Patent Application Publication
(10) Pub. No.: US 2016/0035075 A1
(43) Pub. Date: Feb. 4, 2016

(54) ELECTRONIC APPARATUS AND IMAGE PROCESSING METHOD

(71) Applicant: KABUSHIKI KAISHA TOSHIBA, Tokyo (JP)

(72) Inventor: Koji Yamamoto, Ome Tokyo (JP)

(21) Appl. No.: 14/879,801

(22) Filed: Oct. 9, 2015

Related U.S. Application Data
(63) Continuation of application No. PCT/JP2013/060849, filed on Apr. 10, 2013.

(51) Int. Cl. G06T 5/50; G06T 7/00; G06K 9/46; G06T 3/00; G06T 11/60

(52) U.S. Cl. CPC G06T 5/50; G06T 3/00; G06T 11/60; G06K 9/4661; G06T 7/004; G06K 2009/4666

(57) ABSTRACT

According to one embodiment, an electronic apparatus includes a processor. The processor aligns a second image with a first image, the first image including a subject captured from a first position, the second image including the subject captured from a position different from the first position. The processor calculates a first weight for each pixel in the first image and a second weight for each pixel in the aligned second image. The processor calculates a composite image by adding each pixel in the first image to the corresponding pixel in the aligned second image based on the first weight for each pixel in the first image and the second weight for each pixel in the aligned second image.

### CROSS REFERENCE TO RELATED APPLICATIONS

This application is a Continuation Application of PCT Application No. PCT/JP2013/060849, filed Apr. 10, 2013, the entire contents of which are incorporated herein by reference.

### FIELD

Embodiments described herein relate generally to an electronic apparatus which processes an image, and an image processing method applied to the electronic apparatus.

### BACKGROUND

In recent years, various electronic apparatuses capable of capturing images, such as personal computers, PDAs, mobile phones, and smartphones, which are equipped with a camera, and digital cameras have become widespread.

These electronic apparatuses are used to capture not only images of people or scenery, but also material printed in magazines, written in notebooks, etc., or posted on bulletin boards, etc. Images generated by the capturing are used to be saved as an archive of a personal record, for example, or viewed by people

Meanwhile, with a subject such as a whiteboard whose surface is likely to be reflected, the glare caused by the reflection of the subject sometimes occurs. In an image including such a subject photographed, depending on the glare, information on the subject (for example, characters written on the whiteboard) may be missing.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an appearance of an electronic apparatus according to an embodiment.

FIG. 2 is an exemplary block diagram illustrating the system configuration of the electronic apparatus of the embodiment.

FIG. 3 is a block diagram illustrating a functional configuration of an image processing program executed by the electronic apparatus of the embodiment.

FIG. 4 is a view for explaining an example of reducing a glare in an image using images by the electronic apparatus of the embodiment.

FIG. 5 is a view for explaining an example of combining the images illustrated in FIG. 4.

FIG. 6 is a flowchart showing an example of the procedure of reflection reduction process executed by the electronic apparatus of the embodiment.

### DETAILED DESCRIPTION

Various embodiments will be described hereinafter with reference to the accompanying drawings.

In general, according to one embodiment, an electronic apparatus includes a processor. The processor is configured to align a second image with a first image, the first image including a subject captured from a first position, the second image including the subject captured from a position different from the first position. The processor is configured to calculate a first evaluation value for each pixel in the first image. The processor is configured to calculate a second evaluation value for each pixel in the aligned second image, each pixel in the aligned second image corresponding to each pixel in the first image. The processor is configured to calculate a first weight for each pixel based on the first evaluation value for each pixel and a second weight for each pixel based on the second evaluation value for each pixel. The processor is configured to calculate a composite image by adding each pixel in the first image to the corresponding pixel in the aligned second image based on the first weight for each pixel in the first image and the second weight for each pixel in the aligned second image.

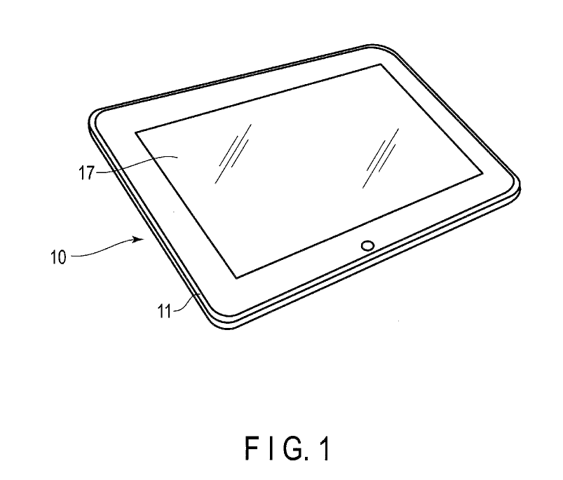

FIG. 1 is a perspective view showing an appearance of an electronic apparatus according to an embodiment. The electronic apparatus can be realized as tablet computers, notebook personal computers, smartphones, PDAs, or an embedded system which can be incorporated into various electronic apparatuses such as digital cameras. In the following descriptions, a case where the electronic apparatus is realized as a tablet computer 10 is assumed. The tablet computer 10 is a portable electronic apparatus which is also referred to as a tablet or a slate computer. The tablet computer 10 includes a main body 11 and a touchscreen display 17, as shown in FIG. 1. The touchscreen display 17 is arranged to be laid over a top surface of the main body 11.

The main body 11 includes a thin box-shaped housing. In the touchscreen display 17, a flat-panel display, and a sensor configured to detect a contact position of the stylus or the finger on a screen of the flat-panel display are incorporated. The flat-panel display may be, for example, a liquid crystal display (LCD). As the sensor, a capacitive touchpanel or an electromagnetic induction-type digitizer, for example, can be used.

In addition, in the main body 11, a camera module for capturing an image from the side of the lower surface (back surface) of the main body 11 is provided.

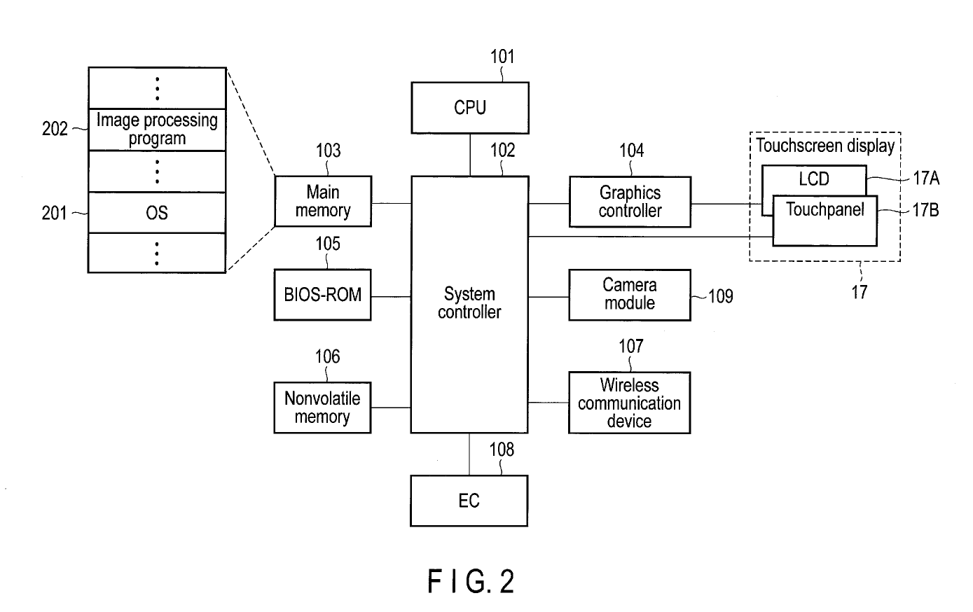

FIG. 2 is a diagram showing a system configuration of the tablet computer 10.

As shown in FIG. 2, the tablet computer 10 includes a CPU 101, a system controller 102, a main memory 103, a graphics controller 104, a BIOS-ROM 105, a nonvolatile memory 106, a wireless communication device 107, an embedded controller (EC) 108, a camera module 109, etc.

The CPU 101 is a processor for controlling the operation of various modules in the tablet computer 10. The CPU 101 executes various kinds of software loaded into the main memory 103 from the nonvolatile memory 106, which is a storage device. These kinds of software include an operating system (OS) 201, and various application programs. The application programs include an image processing program 202. The image processing program 202 has the function of reducing the glare on a subject which is included in an image captured with the camera module 109, the function of reducing (removing) noise in an image, the function of sharpening an image, etc.

Further, the CPU 101 executes a Basic Input/Output System (BIOS) stored in the BIOS-ROM 105. The BIOS is a program for controlling hardware.

The system controller 102 is a device for connecting between a local bus of the CPU 101 and the various components. In the system controller 102, a memory controller for access controlling the main memory 103 is also integrated. Also, the system controller 102 has the function of communicating with the graphics controller 104 via a serial bus conforming to the PCI EXPRESS standard.

The graphics controller 104 is a display controller for controlling an LCD 17A which is used as a display monitor of the tablet computer 10. A display signal generated by the graphics controller 104 is transmitted to the LCD 17A. The LCD 17A displays a screen image based on the display signal. A touchpanel 17B is arranged on the LCD 17A.

The wireless communication device 107 is a device configured to execute wireless communication such as a wireless LAN or 3G mobile communication. The EC 108 is a one-chip microcomputer including an embedded controller for power management. The EC 108 has the function of powering the tablet computer 10 on or off in accordance with the power button operation by the user.

The camera module 109 captures an image as the user touches (taps) a button (a graphical object) displayed on a screen of the touchscreen display 17, for example. The camera module 109 can also capture sequential images such as a moving image.

Incidentally, when a subject which is likely to have the glare by reflection, such as a whiteboard or glossy paper, is photographed with the camera module 109, the so-called flared highlights (halation) caused by sunlight or a fluorescent lamp in a room are sometimes exhibited in the captured image. In a region in which the flared highlights are exhibited in the image, there is a possibility that a character or a figure written on the whiteboard, for example, will be missed.

Accordingly, in the present embodiment, by using images that are generated by photographing the subject from different positions or angles, that is, by using images which have the flared highlights (the glares) at different positions in the image, an image in which the glares are reduced is generated.

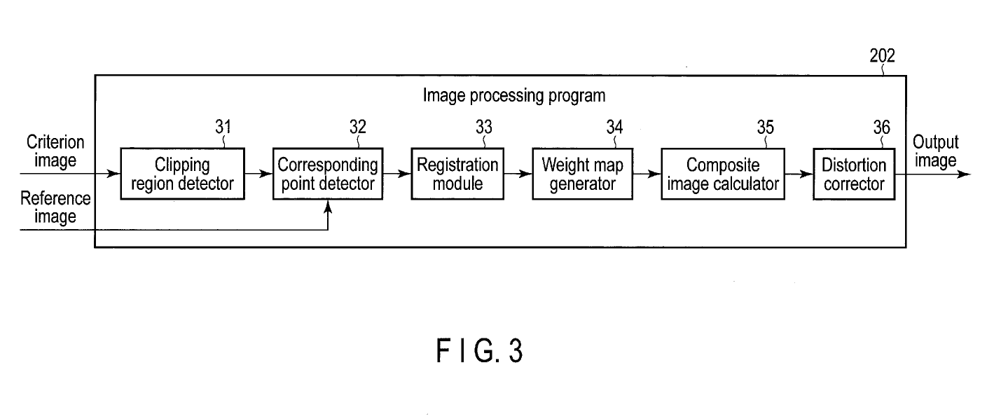

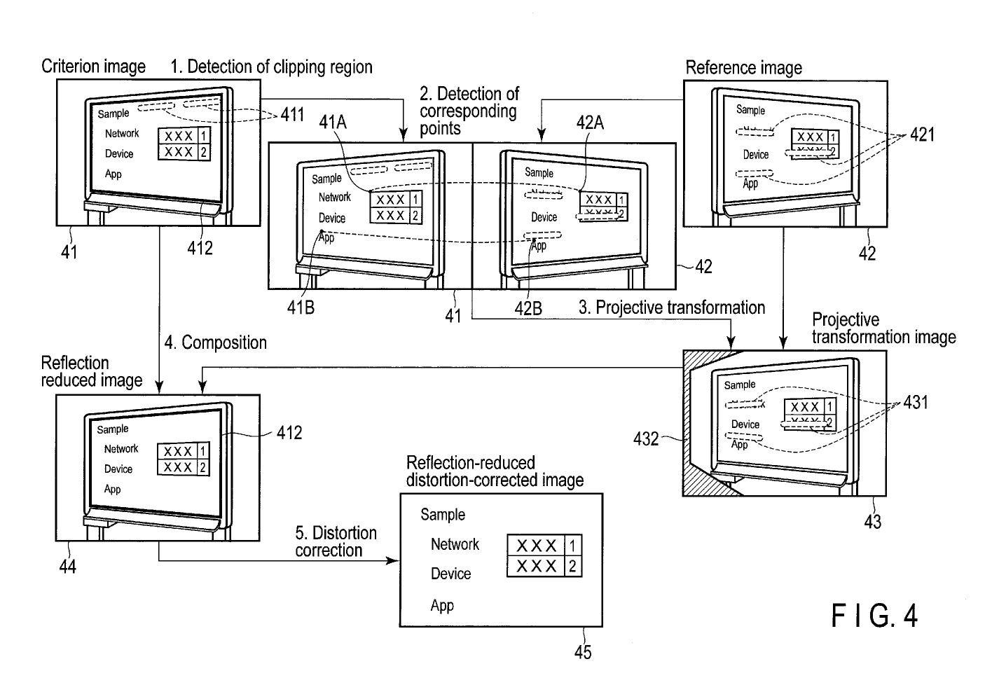

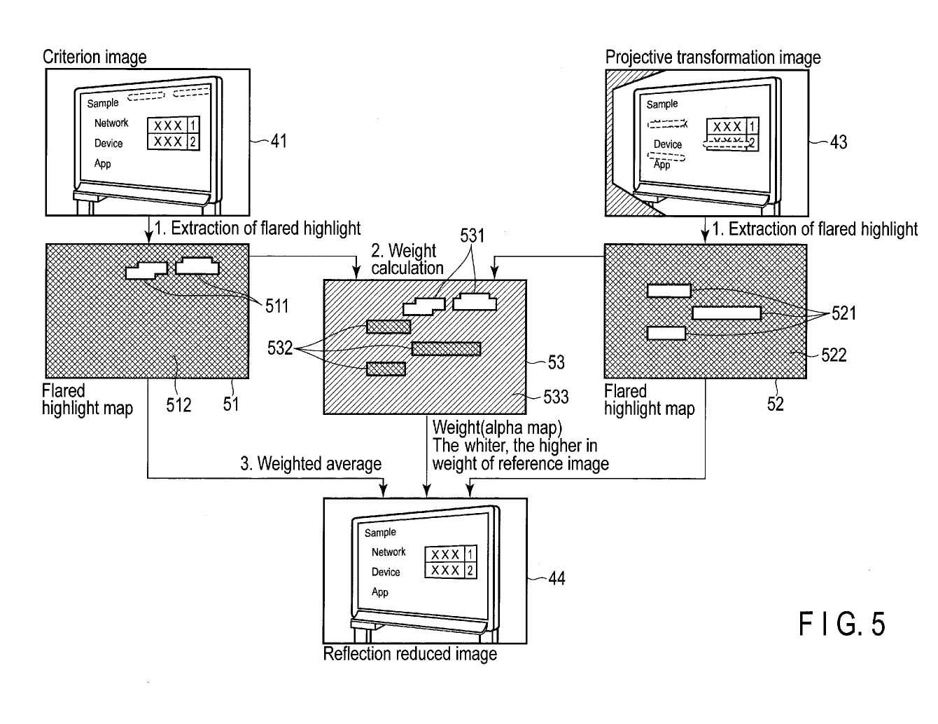

Now, an exemplary functional configuration of the image processing program 202 executed by the computer 10 of the embodiment will be explained below with reference to FIG. 3. The image processing program 202 includes, for example, a clipping region detector 31, a corresponding-point detector 32, a registration module 33, a weight map generator 34, a composite image calculator 35, and a distortion corrector 36. Images captured by the camera module 109 are inputted into the image processing program 202, for example. It should be noted that an example where two images 41 and 42 are inputted will be explained below with reference to FIGS. 4 and 5. However, the image processing program 202 can process arbitrary numbers of images in the similar manner.

The camera module 109 generates a criterion image (first image) 41. The camera module 109 generates (captures) a criterion image 41 in response to an instruction of capturing by a user, for example. In the criterion image 41, a glare (that is, flared highlights) by reflection is occurred.

The clipping region detector 31 detects a clipping region 412, which corresponds to an output image, from the criterion image 41. For example, the clipping region detector 31 detects edges in the criterion image 41 using pixel values (brightness values) of pixels in the criterion image 41. The clipping region detector 31 detects as the clipping region 412 the largest quadrangle constituted by the detected edges. Thereby, a region where the whiteboard (subject) occupies is detected as the clipping region 412, for example.

Moreover, the camera module 109 generates a reference image (second image) 42. The camera module 109 generates (captures) a reference image 42 in the same way as the criterion image 41 in response to the user's instruction of capturing, for example. The camera module 109 generates the reference image 42 which has glare regions 421 which are different in location from the glare regions 411 in the criterion image 41 by capturing a subject from a position different from the position where the criterion image 41 was taken.

The corresponding-point detector 32 and the registration module 33 align with the criterion image 41 in one view of a subject (e.g. a whiteboard) the reference image 42 in another view of the subject. That is, the corresponding-point detector 32 and the registration module 33 align the reference image 42 in such a manner that the position of each pixel in the reference image 42 matches with the position of a corresponding one of the pixels in the criterion image 41.

First, the corresponding-point detector 32 detects corresponding points of the criterion image 41 and the reference image 42. More specifically, the corresponding-point detector 32 detects feature points in each of the criterion image 41 and the reference image 42. The feature points indicate corners, etc. in an image which are detected by using local features, including a scale-invariant feature transform (SIFT) or speeded-up robust features (SURF), which have robustness against the rotation or deformation of a subject in the image. Multiple feature points may be detected in an image. The corresponding-point detector 32 detects a feature point in the reference image 42 which corresponds to a feature point in the criterion image 41 by using the feature points detected in each of the criterion image 41 and the reference image 42, thereby detecting corresponding points of the criterion image 41 and the reference image 42.

In the example illustrated in FIG. 4, the corresponding-point detector 32 detects a feature point 42A in the reference image 42 which corresponds to a feature point 41A in the criterion image 41. That is to say, the corresponding-point detector 32 detects as corresponding points the feature point 41A in the criterion image 41 and the feature point 42A in the reference image 42. Similarly, the corresponding-point detector 32 detects a feature point 42B in the reference image 42 which corresponds to a feature point 41B in the criterion image 41. That is, the corresponding-point detector 32 detects as corresponding points the feature point 41B in the criterion image 41 and the feature point 42B in the reference image 42. Similarly, the corresponding-point detector 32 detects many corresponding points of the criterion image 41 and the reference image 42.

The registration module 33 subjects the reference image 42 to a projective transformation based on the detected corresponding points. More specifically, the registration module 33 determines a projective transformation coefficient (coefficients) that aligns points in the reference image 42 with the corresponding points in the criterion image 41. The registration module 33 estimates the projective transformation coefficient from the corresponding points using, for example, least squares or random sample consensus (RANSAC). Alternatively, the registration module 33 may extract reliable corresponding points by filtering based on reliability, and estimate a projective transformation coefficient (coefficients) using the extracted corresponding points.

The registration module 33 subjects the reference image 42 to a projective transformation based on the estimated projective transformation coefficient (coefficients), thereby generating a transformed image (a projective transformation image) 43. As illustrated in FIG. 4, the glare regions 421 in the reference image 42 are also changed into glare regions 431 in the projective transformation image 43 by this projective transformation. A region 432 in the projective transformation image 43 indicates that the reference image 42 does not have any pixels that correspond to the pixels in the projective transformation image 43.

The registration module 33 registers the criterion image 41 and the reference image 42 by subjecting each of the criterion image 41 and the reference image 42 to, for example, a distortion correction (rectangle correction) based on the clipping region of the subject (for example, the region of a whiteboard) in each image. However, in order to perform such registration it is necessary to detect a clipping region in each of the images and to subject each of the images to distortion correction using an image corresponding to each of the clipping regions.

Therefore the system configuration of detecting the clipping region 412 from the criterion image 41 and generating the projective transformation image 43 from the reference image 42 using the corresponding points of the criterion image 41 and the reference image 42 makes it possible to shorten processing time in comparison with the configuration of detecting a clipping region in each of the criterion image 41 and the reference image 42 and subjecting each of the criterion image 41 and the reference image 42 to a distortion correction based on the clipping regions. Accordingly, usability will be improved.

The weight map generator 34 and the composite image calculator 35 combine the criterion image 41 and the projective transformation image 43 (that is, the reference image 42 which has been subjected to a projective transformation) and thereby generating the reflection-reduced image 44.

The weight map generator 34 calculates a first evaluation value corresponding to a pixel in the criterion image 41, and calculates a second evaluation value corresponding to a pixel in the projective transformation image 43 into which the reference image 42 has been transformed. The weight map generator 34 then calculates a weight based on the first evaluation value and the second evaluation value. The first evaluation value indicates a degree of appropriateness of a pixel in the criterion image 41 for combining the criterion image 41 and the projective transformation image 43 (that is, calculation of a composite image). The second evaluation value indicates a degree of appropriateness of a pixel in the projective transformation image 43 for combining the criterion image 41 and the projective transformation image 43 (calculation of a composite image). The weight map generator 34 estimates, for example, whether a flared highlight caused by a glare has occurred in a certain pixel, and set an evaluation value of the pixel to be smaller with increasing a possibility that a flared highlight has occurred.

More specifically, the weight map generator 34 generates, as illustrated in FIG. 5, a first flared highlight map (first evaluation values) 51 using the criterion image 41, and generates a second flared highlight map (second evaluation values) 52 using the projective transformation image 43 of the reference image 42.

The weight map generator 34 recognizes a pixel in the criterion image 41 as a flared highlight when the pixel value of the pixel falls within a first range, and recognizes a pixel in the projective transformation image 43 as a flared highlight when the pixel value of the pixel falls within a second range. When the pixel value of a pixel in the criterion image 41 falls within the first range, the weight map generator 34 sets a first value (for example, 0) to the evaluation value of the pixel, whereas, when the pixel value of the pixel in the criterion image 41 falls outside the first range, the weight map generator 34 sets a second value larger than the first value (for example, 1) to the evaluation value of the pixel. Similarly, when the pixel value of a pixel in the projective transformation image 43 falls within the second range, the weight map generator 34 sets a first value (for example, 0) to the evaluation value of the pixel, whereas, when the pixel value of a pixel in the projective transformation image 43 falls outside the second range, the weight map generator 34 sets a second value larger than the first value (for example, 1) to the evaluation value of the pixel. It should be noted that the first range is determined by analyzing pixels in the criterion image 41, and the second range is determined by analyzing pixels in the projective transformation image 43 (or reference image 42).

It should be noted that the weight map generator 34 may recognize a pixel in the reference image 41 as a flared highlight when the pixel value (brightness value) of the pixel is equal to or larger than a first threshold, and recognize a pixel in the projective transformation image 43 as a flared highlight when the pixel value of the pixel is equal to or larger than a second threshold. When the pixel value of the pixel in the criterion image 41 is equal to or larger than the first threshold, the weight map generator 34 sets a first value (for example, 0) to the evaluation value of the pixel, whereas, when the pixel value of a pixel in the criterion image 41 is smaller than the first threshold, the weight map generator 34 sets a second value (for example, 1) larger than the first value to the evaluation value of the pixel. Similarly, when the pixel value of a pixel in the projective transformation image 43 is equal to or larger than the second threshold, the weight map generator 34 sets a first value (for example, 0) to the evaluation value of the pixel, whereas, when the pixel value of a pixel in the projective transformation image 43 is smaller than the second threshold, the weight map generator 34 sets a second value (for example, 1) larger than the first value to the evaluation value of the pixel. It should be noted that the first threshold is determined by analyzing pixels in the criterion image 41, and the second threshold is determined by analyzing pixels in the projective transformation image 43 (or reference image 42).

Consequently, in each of the flared highlight maps 51 and 52, the weight map generator 34 sets a small evaluation value (for example, 0) to each of regions 511 and 521 where a flared highlight has been recognized, and sets a large evaluation value (for example, 1) to each of the other regions 512 and 522.

Moreover, when a subject is a whiteboard or a blackboard, the weight map generator 34 may estimate the region as a whiteboard or a blackboard according to whether a pixel falls within a third range in terms of brightness and color. In such a case, the weight map generator 34 enlarges the evaluation value of the region estimated to be a whiteboard or a blackboard. Furthermore, the third range is determined using the known information on a subject (for example, the known features of the whiteboard or blackboard).

The weight map generator 34 generates a weight map (an alpha map) 53 using the generated first flared highlight map 51 and the generated second flared highlight map 52. The weight map 53 includes weights a for performing an alpha blending of the projective transformation image 43 and the criterion image 41, for example. The weight map 53 indicates weight α for each of the pixels on one image. Weight α is a value from 0 to 1, for example. In such a case, a weight for a pixel on the other image will be (1-α).

The weight map 53 is configured to make small the weight assigned to a pixel (pixel value) of the criterion image 41 whereas to make large the weight assigned to a pixel of the projective transformation image 43 of the reference image 42 at a position where a flared highlight is detected in the criterion image 41 (for example, a position which has an evaluation value of 0 in the first flared highlight map 51). The weight map 53 is configured to make large the weight applied to the pixel of the criterion image 41 whereas to make small the weight applied to the pixel of the projective transformation image 43 at a position where a flared highlight is detected in the projective transformation image 43 (for example, a position which has an evaluation value of 0 in the second flared highlight map 52).

That is, the weight map 53 is so configured to make the weight assigned to a pixel (pixel value) of the criterion image 41 larger than the weight assigned to a pixel of the projective transformation image 43 when the evaluation value on the first flared highlight map 51 is larger than the corresponding evaluation value on the second flared highlight map 52. When an evaluation value in the first flared highlight map 51 is smaller than a corresponding evaluation value in the second flared highlight map 52, the weight map 53 is configured to make the weight assigned to the pixel of the criterion image 41 smaller than the weight assigned to the pixel of the projective transformation image 43. Furthermore, when the evaluation value of the first flared highlight map 51 is equal to the corresponding evaluation value of the second flared highlight map 52, it is configured to make equal the weight assigned to the pixel of the criterion image 41 and the weight assigned to the pixel of the projective transformation image 43.

In the example illustrated in FIG. 5, flared highlights are detected in the pixels in the criterion image 41 which correspond to regions 511 in the first flared highlight map 51 (an evaluation value of a pixel in the criterion image 41=0). Flared highlights are also detected in the pixels in the projective transformation image 43 which correspond to area 521 in the second flared highlight map 52 (an evaluation value of a pixel in the projective transformation image 43=0).

Therefore, weights 531 in the weight map 53 which correspond to regions 511 in the first flared highlight map 51 are set in a such a manner that the weights assigned to pixels in the criterion image 41 are small and the weights assigned to pixels in the projective transformation image 43 are large. Moreover, weights 532 in the weight map 53 which correspond to regions 521 in the second flared highlight map 52 are set in such a manner that the weights assigned to the pixels in the criterion image 41 are large and the weights assigned to the pixels in the projective transformation image 43 are small. Furthermore, weights 533 in the weight map 53 which correspond to regions 512 and 522 other than regions 511 and 521 are set in such a manner that the weights assigned to the pixels in the criterion image 41 is equal to the weights assigned to the pixels in the projective transformation image 43, for example.

It is assumed, for example, that the weight map 53 indicates a weight α which is assigned to a pixel in the projective transformation image 43. In such a case, in the weight map 53, “1” is set to each of the weights 531, “0” is set to each of the weights 532, and “0.5” is set to each of the weights 533.

The composite image calculator 35 generates a reflection-reduced image (composite image) 44 by subjecting the criterion image 41 and the projective transformation image 43 of the reference image 42 to a weighted addition (alpha blending) based on the generated weight map 53. The composite image calculator 35 computes the reflection-reduced image 44 by, for example, computing the sum of the pixel value of each pixel in the projective transformation image 43 to which a weight a is assigned, and the pixel value of the corresponding one of the pixels in the criterion image 41 to which a weight (1-α) is assigned.

It should be noted that, in a first region in which any flared highlight has not occurred in both of the criterion image 41 and the projective transformation image 43 (for example, the pixels corresponding to a region 533 of the weight map 53), the composite image calculator 35 may adjust the pixels in the first area of each of the images 41 and 43 to make the brightness (range of brightness) of the first area of the criterion image 41 equal to the brightness of the first area of the projective transformation image 43, and then may generate the reflection-reduced image 44. Moreover, the weight map generator 34 may previously perform a process of blurring the weight map 34 in order to suppress the boundaries (discontinuities) in the reflection-reduced image 44 caused by the boundaries (edges) in the weight map 34. Such a configuration makes it possible to smooth change of pixel values (change of brightness) in the reflection-reduced image 44.

The distortion corrector 36 clips an image corresponding to the clipping region 412 from the computed reflection-reduced image 44. The distortion corrector 36 subjects the clipped image to a distortion correction (transforms the clipped region to a rectangle), thereby acquiring an image 45 which is glare-reduced and is corrected to be a rectangle.

The above configuration makes it possible to reduce a glare on the subject captured in an image. There is only one reference image 42 in the example mentioned above. However, multiple reference images 42 may also be used. In such a case, the weight map generator 34 calculates for a certain pixel evaluation values corresponding to the reference images 42, and computes one evaluation value for the pixel by using the calculated evaluation values.

It is assumed, for example, that there are three reference images 42, that an evaluation value for a pixel is set to 0 when the pixel is a flared highlight pixel, and that an evaluation value for a pixel is set to 1 when the pixel is not a flared highlight pixel. In such a case, the weight map generator 34 determines an evaluation value by majority, for example. That is, when at least two of the three reference images 42 indicate that an evaluation value of a certain pixel is 0, then the evaluation value of the pixel for the whole of the three reference images 42 is set to 0. Moreover, when at least two of the three reference images 42 indicate that an evaluation value of a certain pixel is 1, then the evaluation value of the pixel for the whole of the three reference images 42 is set to 1. In this way, any outlier can be removed by decision by majority, so that not only any flared highlight but also any noise in the images can be reduced.

Furthermore, the above-mentioned evaluation value maps (flared highlight maps) 51 and 52 or the above-mentioned weight map 53 may be computed based on the scaled-down criterion image 41 and the scaled-down projective transformation image 43. In such a case, the composite image calculator 35 combines (applies weighted addition to) the scaled-down criterion image 41 and the scaled-down projective transformation image 43 using the weight map 53 based on the these scaled-down images 41 and 43, and enlarge the combined image by interpolating pixels in the combined image, thereby generating the reflection-reduced image 44. Accordingly, processing time is shortened and the boundary (discontinuity) in the reflection-reduced image 44 is suppressed.

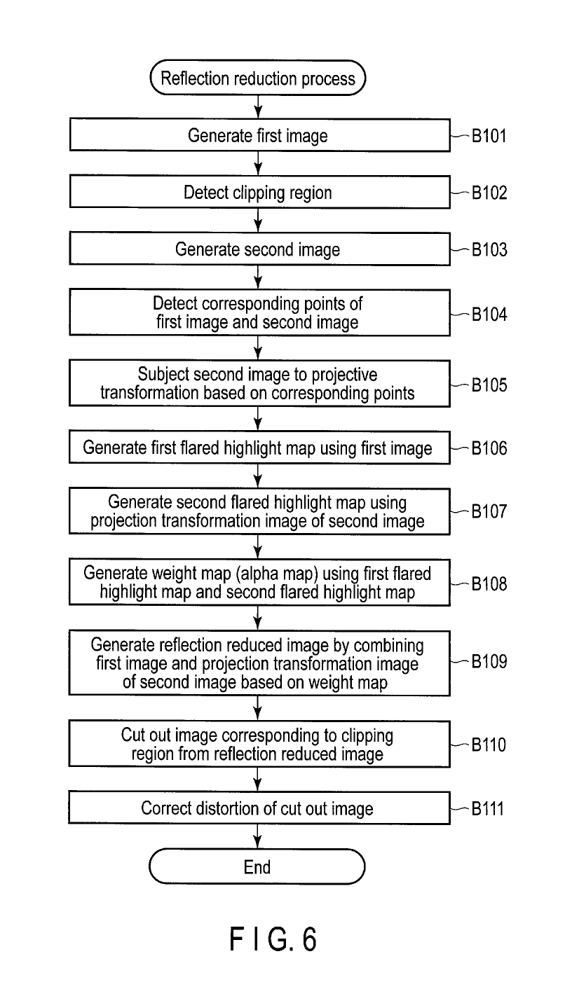

Now, an example of the procedure of the reflection-reduction process executed by the tablet computer 10 will be explained below with reference to the flowchart of FIG. 6.

First, a camera module 109 generates a first image (criterion image) 41 (block B101). The camera module 109 generates a first image 41 in response to the user's instruction to take a photograph, for example. The clipping region detector 31 detects in the first image 41 a clipping region 412 which corresponds to a region acquired as an output image (block B102). The clipping region detector 31 can detect in the first image 41 a region to which the whiteboard (subject) is captured as a clipping region 412, for example.

Moreover, the camera module 109 generates a second image (reference image) 42 (block B103). The camera module 109 generates a second image 42 in the same way as the first image 41 in response to the user's instruction to take a photograph, for example. Furthermore, it is possible to cause the camera module 109 to generate the second image 42 in the block B102 in parallel to the process of detecting a clipping region in the first image 41. Hence, the whole processing time will be shortened.

The corresponding-point detector 32 detects corresponding points of the first image 41 and the second image 42 (block B104). The registration module 33 subjects the second image 42 to a projective transformation based on the detected corresponding-points (block B105).

Subsequently, the weight map generator 34 generates a first flared highlight map 51 using the first image 41 (block B106), and generates a second flared highlight map 52 using the projective transformation image 43 of the second image 42 (block B107). The weight map generator 34 generates a weight map (an alpha map) 53 using the generated first flared highlight map 51 and the generated second flared highlight map 52 (block B108). The weight map 53 includes weights α for carrying out alpha blending of the projective transformation image 43 and the first image 41, for example. Each of the weights α is a value from 0 to 1, for example.

The composite image calculator 35 generates a reflection-reduced image (a composite image) 44 by combining (carrying out alpha blending of) the first image 41 and the projective transformation image 43 of the second image 42 based on the generated weight map 53 (block B109). The composite image calculator 35 computes the reflection-reduced image 44 by, for example, computing the sum of the pixel value of each pixel in the projective transformation image 43 to which a weight α is assigned, and the pixel value of the corresponding one of the pixels in the first image 41 to which a weight (1-α) is assigned.

The distortion corrector 36 cuts out an image from the generated reflection-reduced image 44 corresponding to the clipping region 412 (block B110). The distortion corrector 36 subjects the cut out image to a distortion correction (rectangle correction), thereby acquiring an image 45 in which a glare is reduced and which is corrected to a rectangle (block B111).

It should be noted that a case where a subject is a whiteboard has been explained above. However, the embodiment may be applicable to various subjects, including a glossy paper and a screen of a display, which tend to cause a glare by reflection on photographing just as a whiteboard does.

As has been explained above, the embodiment makes it possible to reduce a glare appearing on a subject captured in an image. The registration module 33 aligns a reference image 42 with a criterion image 41, the criterion image capturing a subject from a first position, the reference image 42 capturing the subject from a position different from the first position. The weight map generator 34 calculates a first evaluation value corresponding to a pixel in the criterion image 41, calculates a second evaluation value corresponding to a pixel in the aligned reference image 42, and calculates a weight based on the first evaluation value and the second evaluation value. The composite image calculator 35 calculates a composite image by subjecting a pixel in the criterion image 41 and a pixel in the aligned reference image 42 to a weighted addition based on the weight. Consequently, an image in which a glare is reduced is acquired using the images 41 and 42 capturing the subject from different positions.

Furthermore, all the procedures of a reflection reduction process of the embodiment can be achieved by using software. Therefore, the same advantages as the embodiment will be easily achieved only by storing on a computer readable storage medium a program for performing the procedures of the reflection reduction process, installing the program in the usual computer for executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a processor configured to:
align a second image with a first image, the first image comprising a subject captured from a first position, the second image comprising the subject captured from a position different from the first position;
calculate a first evaluation value for each pixel in the first image;
calculate a second evaluation value for each pixel in the aligned second image, each pixel in the aligned second image corresponding to each pixel in the first image; and
calculate a first weight for each pixel based on the first evaluation value for each pixel and a second weight for each pixel based on the second evaluation value for each pixel; and
calculate a composite image by adding each pixel in the first image to the corresponding pixel in the aligned second image based on the first weight for each pixel in the first image and the second weight for each pixel in the aligned second image.

2. The electronic apparatus of claim 1, wherein when the first evaluation value is larger than the second evaluation value, a weight assigned to the pixel in the first image is larger than a weight assigned to the pixel in the second image.

3. The electronic apparatus of claim 1, wherein the processor is configured to:
detect each pixel of the second image and corresponding each pixel of the first image;
calculate a transformation coefficient based on the detected each pair of corresponding pixels; and
transform the second image to the aligned second image based on each transformation coefficient.

4. The electronic apparatus of claim 3, wherein the transformation comprises a projective transformation.

5. The electronic apparatus of claim 1, wherein:
the first evaluation value is indicative of a degree of appropriateness of the pixel in the first image for calculating the composite image;
the second evaluation value indicates a degree of appropriateness of the pixel in the second image for calculating the composite image; and
the processor is configured to:
set a first value to the first evaluation value when a pixel value in the first image is within a first range;
set a second value larger than the first value to the first evaluation value when a pixel value in the first image is outside the first range;
set the first value to the second evaluation value when a pixel value in the second image is within a second range; and
set the second value to the second evaluation value when a pixel value is outside the second range.

6. The electronic apparatus of claim 1, wherein the first evaluation value is indicative of a degree of appropriateness of the pixel in the first image for calculating the composite image,
the second evaluation value is indicative of a degree of appropriateness of the pixel in the second image for calculating the composite image, and
the processor is configured to:
set a first value to the first evaluation value when a pixel value in the first image is equal to or larger than a first threshold;
set a second value larger than the first value to the first evaluation value when a pixel value is smaller than the first threshold;
set the first value to the second evaluation value when a pixel value in the second image is equal to or larger than a second threshold; and
set the second value to the second evaluation value when a pixel value is smaller than the second threshold.

7. The electronic apparatus of claim 1, wherein the first evaluation value is indicative of whether the pixel in the first image is a flared highlight pixel, and
the second evaluation value is indicative of whether the pixel in the second image is a flared highlight pixel.

8. The electronic apparatus of claim 1, wherein the processor is configured to:
detect a clipping region in the first image;
clip the clipping region from the composite image; and
correct the clipping region to a rectangle.

9. An image processing method comprising:
aligning a second image with a first image, the first image comprising a subject captured from a first position, the second image comprising the subject captured from a position different from the first position;
calculating first evaluation value for each pixel in the first image;
calculating second evaluation value for each pixel in the aligned second image, each pixel in the aligned second image corresponding to each pixel in the first image;
calculating a first weight for each pixel based on the first evaluation value for each pixel and a second weight for each pixel based on the second evaluation value for each pixel; and
calculating a composite image by adding each pixel in the first image to the corresponding pixel in the aligned second image based on the first weight for each pixel in the first image and the second weight for each pixel in the aligned second image.

10. A computer-readable, non-transitory storage medium having stored thereon a program which is executable by a computer, the program controlling the computer to execute functions of:
aligning a second image with a first image, the first image comprising a subject captured from a first position, the second image comprising the subject captured from a position different from the first position;
calculating a first evaluation value for each pixel in the first image,
calculating a second evaluation value for each pixel in the aligned second image, each pixel in the aligned second image corresponding to each pixel in the first image; and
calculating a first weight for each pixel based on the first evaluation value of each pixel and a second weight for each pixel based on the second evaluation value of for each pixel; and
calculating a composite image by adding each pixel in the aligned first image to the corresponding pixel in the aligned second image based on the first weight for each pixel in the first image and the second weight for each pixel in the aligned second image.
